(19) United States
(12) Patent Application Publication
(10) Pub. No.: US 2020/0271427 A1
(43) Pub. Date: Aug. 27, 2020

(54) LEUCO DYE SHOOTING TARGETS

(71) Applicant: JL Darling LLC, Tacoma, WA (US)

(72) Inventors: John T. Mattingly, Fox Island, WA (US); Paul Snowwhite, Dexter, MI (US)

(21) Appl. No.: 16/800,995

(22) Filed: Feb. 25, 2020

Related U.S. Application Data
(60) Provisional application No. 62/810,804, filed on Feb. 26, 2019.

(51) Int. Cl. F41J 5/24; G01N 31/22; C08L 33/08; C08L 25/06; C09D 133/08; C09D 125/06; C08L 33/02; C09D 133/02

(52) U.S. Cl. CPC F41J 5/24; G01N 31/22; C08L 33/08; C08L 25/06; C08K 5/175; C09D 125/06; C08L 33/02; C09D 133/02; C09D 133/08

(57) ABSTRACT

The present disclosure relates to weatherproof or moisture-resistant writable or printable paper or paper-containing substrates (i.e., targets), which include recyclable cellulosic targets coated with a single layer coating and an optional weatherproof coating. The targets visibly react to a projectile, resist degradation, remain legible, can be written upon when wet, and are recyclable.

### BACKGROUND

### Technical Field

The present disclosure is directed to a target comprising substrate (e.g., weather-proof paper) that is coated with a coating that detectably changes color when a stuck with a projectile, as well as preparation and use of the same.

### Background

Military personnel, law enforcement officers, hunters, and sport shooters use firearm targets to hone their marksmanship. Target shooting enables shooters to improve their accuracy and precision at a shooting range or other controlled environment.

Conventional targets include a paper substrate and a target image printed directly onto the paper substrate. A typical target image may include a bull's eye with concentric rings. However, a drawback of conventional targets is that it may be difficult for shooters to see the bullet holes from a distance, especially in inclement weather. This problem is exacerbated in darker environments (e.g., a cloudy or rainy day) and with smaller caliber rounds.

Multi-layer targets containing multiple different colored layers are known and are sometimes used in an effort to combat issues related to visibility; however, these targets suffer from various limitations. Multi-layer targets take at least 4 layers of print and are easily damaged during handling. These targets are easily damaged because a top layer is coated onto other layers with intentionally poor adhesion properties so that it detaches when penetrated to expose sublayers.

Accordingly, there remains a need in the art for targets with improved durability that can provide good visibly discernable markings when hit. Additionally, a target having the aforementioned properties and also being robust enough to be used in inclement weather are highly desirable. The present disclosure fulfills these needs and provides further related advantages.

### BRIEF DESCRIPTION

Generally, the present disclosure relates to a target that detectably changes color when stuck with a projectile (e.g., a bullet). One embodiment provides a target comprising a substrate having a thickness between 0.001 mm and 1.0 mm and two substantially planar sides, a single layer coating on at least one planar side of the substrate comprising an encapsulated dye and media, wherein the dye detectably changes color when kinetic energy is applied to the target (e.g., when a projectile such as a bullet hits). In some more specific embodiments, the substrate is weatherproof paper.

In certain aspects, the present disclosure provides a target including: a substrate having a thickness between 0.001 mm and 1.0 mm and two substantially planar sides; and a single layer coating on at least one planar side of the substrate comprising an encapsulated dye and media, wherein the dye detectably changes color in response to kinetic energy applied to the target.

In some embodiments, the dye is a leuco dye. In some embodiments, the dye is a lactone, a phthalein, an oxazine, a redox indicator, or a combination thereof.

In some embodiments, the dye is a lactone or a phthalein.

In some embodiments, the dye is a lactone, such as crystal violet lactone.

In some embodiments, the dye is a phthalein, such as phenolphthalein or thymolphthalein.

In some embodiments, the substrate has a Taber stiffness greater than about 10 mN as measured by ISO 17025 and/or a Clarke stiffness greater than about 0.05 gf·cm as measured by Tappi T451.

In some embodiments, the substrate and single layer coating together have a Taber stiffness greater than about 10 mN as measured by ISO 17025 and/or a Clarke stiffness greater than about 0.05 gf·cm as measured by Tappi T451.

In some embodiments, the target is substantially free of silicone.

In some embodiments, the substrate includes a plurality of cellulose fibers.

In some embodiments, the substrate is in direct contact with and impregnantly covered by a weatherproof coating on at least one of the two substantially planar sides, the weatherproof coating comprising a plurality of first polymers.

In some embodiments, the substrate and weatherproof coating together include at least one cross-link between:

i) one of the plurality of cellulose fibers and one of the plurality of first polymers;

ii) two of the plurality of first polymers; or

iii) two of the plurality of cellulose fibers.

In some embodiments, the first polymer includes at least one polyacrylic polymer.

In some embodiments, the first polymer includes at least one polystyrene polymer.

In some embodiments, the first polymer includes a copolymer.

In some embodiments, the copolymer includes at least one polyacrylic polymer and at least one polystyrene polymer.

In some embodiments, the first polymer includes polystyrene, poly butyl acrylate, poly 2-ethylhexyl acrylate, polyacrylic acid or a mixture thereof.

The weatherproof coating may further include a plurality of second polymers.

In some embodiments, the second polymer is a copolymer.

In some embodiments, the first polymer includes a polyacrylic polymer and the second polymer includes a styrene acrylic copolymer.

In some embodiments, the density of the weatherproof coating on the target ranges from about 0.5 grams per square meter of the target to about 10.0 grams per square meter of the target.

In some embodiments, the weatherproof coating has a total polymer content of less than 85% by weight, based on the total weight of the weatherproof coating.

In some embodiments, the weatherproof coating further includes a wax.

In some embodiments, the wax includes a paraffin wax, a polypropylene-wax mixture, a polyethylene-wax mixture, carnauba wax, microcrystalline wax, montan wax, a Fisher-Tropsch wax, beeswax or a mixture thereof.

In some embodiments, the plurality of cellulose fibers are derived from recycled paper.

In some embodiments, the substrate is paper.

In some embodiments, the thickness of the paper ranges from 0.007 mm to 0.35 mm.

In some embodiments, the at least one cross-link comprises one of the following structures (I), (II), (III) or (IV):

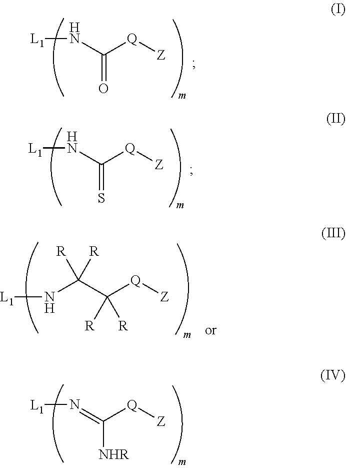

wherein:

Li is a multi-valent linker comprising optionally substituted alkylene, haloalkylene, cycloalkylene, heteroalkylene, haloheteroalkylene, cycloheteroalkylene, arylene, haloarylene, or haloheteroarylene;

m is an integer greater than 1;

Q is O, S or NR^{a}, wherein R^{a} is H or alkyl;

R is at each occurrence, independently H, alkyl, cycloalkyl, alkylaminoalkyl or halo; and

Z is at each occurrence, independently H, one of the first polymers or one of the cellulose fibers, provided that Z is not H for at least two occurrences.

In some embodiments, the kinetic energy is greater than about 150 joules.

In some embodiments, the kinetic energy is greater than about 1,500 joules.

In some embodiments, the single layer coating further includes the weatherproof coating.

In certain aspects, the present disclosure provides a device, such as a target, that includes: a flexible paper-based substrate having a first surface opposite a second surface; a pattern on the first surface of the substrate, the pattern including a plurality of visual indicators; and a first coating on the first surface of the substrate, the first coating including an encapsulated dye and media, in response to kinetic energy from a projectile, the first coating changes color.

These and other aspects of this disclosure will be evident upon reference to the following detailed description of the disclosure.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale and some of these elements are enlarged and positioned to improve figure legibility. Further, the particular shapes of the elements as drawn, are not intended to convey any information regarding the actual shape of the particular elements, and have been solely selected for ease of recognition in the figures.

FIG. 1 shows a visually detectable color change (from white to black or dark grey) following a .22 caliber bullet shot through the substrate.

FIG. 2 shows an exemplary substrate with a printed target design.

FIG. 3 depicts an exemplary substrate with a printed target design.

FIG. 4 is an exemplary substrate with a printed target design.

FIG. 5 shows an exemplary substrate with a printed target design.

### DETAILED DESCRIPTION

The present disclosure provides shooting targets that are durable and change color or are otherwise visually detectable in response to a projectile. In one embodiment, the shooting target only includes a single ink containing layer that is configured to react to a projectile. Additionally, embodiments of targets of the present disclosure provide high visibility when hit with a projectile and are usable in all kinds of environments, including inclement weather. These targets can be weatherproof and recyclable.

Some embodiments provide a target comprising a substrate having a thickness between 0.001 mm and 1.0 mm and two substantially planar sides, such as a flexible sheet. At least a single layer coating including an encapsulated dye and media are applied to at least one side of the substrate. In response to a projectile or other kinetic energy, the dye detectably changes color in a location that receives the kinetic energy.

In some embodiments, the coating includes a color-changing dye. A color-changing dye refers to a dye that is capable of changing color when exposed to a stimulus, such as a change in pH, a change in temperature, or exposure to light. In particular embodiments, the color-changing dye changes color in response to heat or kinetic energy. In particular embodiments, the color-changing dye changes color in response to a change in pH or a change in reduction/oxidation.

In some embodiments, the coating includes a color changing dye that is encapsulated. In some embodiments, the encapsulated color-changing dye is encapsulated within capsules that are capable of releasing the color-changing dye in response to the kinetic energy.

“Single-layer coating” as used herein refers to a layer coating on a target that is sufficient for providing a color-changing property to the target, without requiring additional layers. This is in contrast to targets that require multiple coating layers for color-detection of contact with a projectile. For example, a single layer coating may be a coating that includes a color-changing dye that changes colors in response to kinetic energy. The color-changing dye may be a dye that changes color in response to kinetic energy, such as a thermo-reactive dye. As another example, a single layer coating may be a coating that includes a color-changing dye encapsulated within capsules that are mixed into a media that includes a component capable of reacting with the dye and causing the dye to change colors. In this scenario, when the target is subjected to physical force (e.g., from a projectile), the encapsulated dye is released from the capsules and exposed to the reactive component in the media, thereby causing the dye to change color. A target that includes a single-layer coating for dye-based detection of target contact may include additional coatings that serve other functions, such as a weatherproof coating.

“Encapsulated” as used herein refers to the color-changing dye being compartmentalized from the media such that the media and the color-changing dye are not in direct contact. In some embodiments, the color-changing dye is encapsulated within capsules. The capsules may be polymer-based capsules containing the color-changing dye. Polymer-based capsules may be made of plant-based polymers, such as gelatin. In some embodiments, the capsules are made of a material that, upon exposure to kinetic energy (e.g., caused by a bullet) is capable of releasing the color-changing dye.

In some specific embodiments, the coating includes a leuco dye (e.g., crystal violet lactone, phenolphthalein, thymolphthalein, and/or redox indicators). A leuco dye is a dye that changes between two chemical forms; one that is colorless. The present disclosure includes irreversible transformations that involve reduction or oxidation.

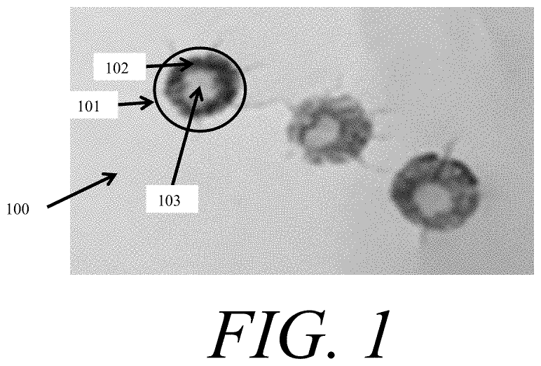

The target may be colorless when the leuco dye is applied to the substrate, such as a white target. Ink may be applied to the substrate to identify a bulls-eye or other pattern that can be used by a shooter for aiming and practice. Upon interaction with a bullet or other projectile, such as an arrow, an area around a penetration point will change from colorless to a color, making the area more visible. FIG. 1 is an enhanced view of an embodiment of the present disclosure including a first area 101 (circled) associated with a first projectile that penetrated a substrate 100. The dark portion 102 is a result of the dye detectably changing color in the area surrounding a hole formed as a result of the portion of the substrate that received kinetic energy (i.e., was penetrated by a bullet). The dark portion 102 surrounds the area 103 that was penetrated by a 0.22 caliber bullet.

The particulars described herein are by way of example and are only for purposes of illustrative discussion of embodiments of the present disclosure. The use of any and all examples, or exemplary language (e.g., “such as” or “for example”) provided herein is merely intended to better illuminate the disclosure and does not pose a limitation on the scope of the disclosure as claimed. No language in the specification should be construed as indicating any non-claimed element is essential to the practice of the disclosure. Further, all methods described herein can be performed in any suitable order unless otherwise indicated herein or otherwise clearly contradicted by context.

The use of the alternative (e.g., “or”) should be understood to mean one, both, or any combination thereof of the alternatives. The various embodiments described above can be combined to provide further embodiments. Groupings of alternative elements or embodiments of the disclosure described herein should not be construed as limitations. Each member of a group may be referred to and claimed individually, or in any combination with other members of the group or other elements found herein.

Each embodiment disclosed herein can comprise, consist essentially of, or consist of a particular stated element, step, ingredient, or component. As used herein, the term “comprise” or “comprises” means “includes, but is not limited to,” and allows for the inclusion of unspecified elements, steps, ingredients, or components, even in major amounts. As used herein, the phrase “consisting of” excludes any element, step, ingredient, or component that is not specified. As used herein, the phrase “consisting essentially of” limits the scope of the embodiment to the specified elements, steps, ingredients, or components, and to those that do not materially affect the basic and novel characteristics of the claimed disclosure.

The terms “a,” “an,” “the,” and similar articles or terms used in the context of describing the disclosure (especially in the context of the following claims) are to be construed to cover both the singular and the plural (i.e., “one or more”), unless otherwise indicated herein or clearly contradicted by context. Ranges of values recited herein are intended to serve as a shorthand method of referring individually to each separate value falling within the range. In the present description, any concentration range, percentage range, ratio range, or integer range is to be understood to include the value of any integer within the recited range and, when appropriate, fractions thereof (such as one tenth and one hundredth of an integer), unless otherwise indicated. Also, any number range recited herein relating to any physical feature, such as size or thickness, are to be understood to include any integer within the recited range, unless otherwise indicated. Unless otherwise indicated herein, each individual value is incorporated into the specification as if it were individually recited herein.

The term “about” has the meaning reasonably ascribed to it by a person of ordinary skill in the art when used in conjunction with a stated numerical value or range, i.e., denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Definitions used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3^{rd} Edition or a dictionary known to those of ordinary skill in the art.

The terms “detectable” and “visually detectable” are used herein to refer to a change that is observable by visual inspection, without prior illumination, or thermal or chemical activation. For example, the first area 101 (circled) of FIG. 1 includes a dark portion 102 around the opening 103. The dark portion 101 is in sharp contrast to the light or colorless portion of the substrate 100. Such detectable color change refers to a change in an emission spectrum of a dye in a region ranging from about 390 to about 700 nm (i.e., the visible spectrum). The detectable change of color may be observed with or without the aid of an optically based detection device, including, glasses, contact lenses, binoculars, scopes, photographic lenses, and digital cameras. Visually detectable dyes and substances refer to those which emit and/or absorb light in the visible spectrum. For example, the detectable color change will be dependent upon the selected dye in the single layer coating. In some embodiments, the color change is from colorless (i.e., white) to a darker shade (e.g., grey or black). In some embodiments, the color change is from colorless to black. In some embodiments, the color change is from colorless to pink or red. In some embodiments, the color change is from colorless to yellow or orange.

The term “weatherproof” means sufficiently water resistant that a target, despite prolonged exposure to a wet environment, such as one created by substantial rainfall, retains its utility as a surface for legibly bearing machine printed images, or as a surface that can be written upon when wet or dry, using pen or pencil. More specifically, this means that the target resists falling apart when wet and also maintains a substantially intact and undisturbed surface. The weatherproof character of the target is largely a function of water repellency and wet strength. Water repellency refers to the ability of the target to resist wetting, that is, the passage of water into the structural components of the target (e.g., cellulose) through capillary action. In some embodiments, the weatherproof layer is colorless.

“Wet strength” refers to the tensile strength of the target when permeated or soaked with water, the strength being provided by bond between the components of the system (e.g., inter-fiber bonds, fiber-fiber cross-links, fiber-polymer cross-links, polymer-polymer cross-links, etc.) having resistance to attack by water. Without wishing to be bound by theory, strength is believed to be related to entanglement of fibers as well as addition of natural polymers and synthetic resin to pulp slurry during the manufacturing process, which creates a resistance to swelling, protects existing fiber bonds and forms new water resistant bonds. Wet strength can be determined by Tappi Test Method T456 and is routinely expressed as the ratio of wet to dry tensile force at break. Wet strength can be measured as the peak tensile force (in Newtons) at breakage for a target soaked in distilled water for a controlled period of time (e.g., 5 minutes; referred to as “wet strength method”).

In one embodiment, a target comprising a substrate having a thickness between 0.001 mm and 1.0 mm and two substantially planar sides, a single layer coating on at least one planar side of the substrate comprising an encapsulated dye and media, wherein the dye detectably changes color when kinetic energy is applied to the target is presented. In certain embodiments, the substrate comprises cellulose fibers and a weatherproof coating comprising a plurality of first polymers. In more specific embodiments, the substrate and weatherproof coating together comprise at least one cross-link between more than two components, for instance, between more than one of the cellulose fibers, more than one of the first polymers, or combinations thereof. The substrate, in some embodiments is a flexible sheet, such as a sheet of paper.

In some embodiments, the target has a wet strength greater than 0 Newtons. In some more specific embodiments, the target has a wet strength greater than 100 Newtons. In some embodiments, the target has a wet strength greater than 200 Newtons, greater than 300 Newtons, greater than 400 Newtons, greater than 500 Newtons, greater than 600 Newtons, greater than 700 Newtons, greater than 800 Newtons, greater than 900 Newtons, greater than 1,000 Newtons, greater than 1,100 Newtons, greater than 1,200 Newtons, greater than 1,300 Newtons, greater than 1,400 Newtons, greater than 1,500 Newtons, greater than 1,600 Newtons, greater than 1,700 Newtons, greater than 1,800 Newtons, greater than 1,900 Newtons, greater than 2,000 Newtons, greater than 2,100 Newtons, greater than 2,200 Newtons, greater than 2,300 Newtons, greater than 2,400 Newtons, greater than 2,500 Newtons, greater than 2,600 Newtons, greater than 2,700 Newtons, greater than 2,800 Newtons, greater than 2,900 Newtons, or greater than 3,000 Newtons. In any of the forgoing examples, wet strength can be measured using the wet strength method or the Tappi Test Method T456.

The polymers included in the weatherproof coating may contain various functional groups. As used herein, the chemical functional groups referred to herein have the following definitions unless context dictates otherwise. In some embodiments, the media comprises the weatherproof coating. That is, in some embodiments, the single layer coating includes a weatherproof coating. In some embodiments, the single layer coating is separate from the weatherproof coating (e.g., the weatherproof coating impregnantly covers the substrate and the single layer coating is applied onto the impregnantly covered substrate).

“Alkyl” refers to a straight or branched hydrocarbon chain radical consisting solely of carbon and hydrogen atoms, which is saturated or unsaturated (i.e., contains one or more double (alkenyl) and/or triple bonds (alkynyl)), having, for example, from one to twenty-four carbon atoms (C₁-C₂₄ alkyl), four to twenty carbon atoms (C₄-C₂₀ alkyl), six to sixteen carbon atoms (C₆-C₁₆ alkyl), six to nine carbon atoms (C₆-C₉ alkyl), one to fifteen carbon atoms (C₁-C₁₅ alkyl),one to twelve carbon atoms (C₁-C₁₂ alkyl), one to eight carbon atoms (C₁-C₈ alkyl) or one to six carbon atoms (C₁-C₆ alkyl) and which is attached to the rest of the molecule by a single bond, e.g., methyl, ethyl, n-propyl, 1-methylethyl (isopropyl), n-butyl, n-pentyl, 1,1-dimethylethyl (t-butyl), 3-methylhexyl, 2-methylhexyl, ethenyl, prop-1-enyl, but-1-enyl, pent-1-enyl, penta-1,4-dienyl, ethynyl, propynyl, butynyl, pentynyl, hexynyl, and the like. Unless stated otherwise specifically in the specification, an alkyl group is optionally substituted.

“Alkylamino” refers to the group —NRR′, where R and R′ are each independently either hydrogen or alkyl, and at least one of R and R′ is alkyl. Alkylamino includes groups such as piperidino wherein R and R′ form a ring. The term “alkylaminoalkyl” refers to -alkylene-NRR'.

“Alkylene” refers to a straight or branched divalent or multivalent hydrocarbon chain linking the rest of the molecule to a radical group or linking two or more radical groups, consisting solely of carbon and hydrogen, which is saturated or unsaturated (i.e., contains one or more double and/or triple bonds), and having from one to twelve carbon atoms, e.g., methylene, ethylene, propylene, n-butylene, ethenylene, propenylene, n-butenylene, propynylene, n-butynylene, and the like. The alkylene chain is attached to the rest of the molecule and/or radical group(s) through a single or double bond. The points of attachment of the alkylene chain to the rest of the molecule and/or to the radical group(s) can be through one carbon or any two carbons within the chain. Unless stated otherwise specifically in the specification, an alkylene chain is optionally substituted.

“Haloalkylene” refers to an alkylene, as defined above, wherein at least one H is replaced by a halogen radical, for example, fluoro, chloro, bromo, iodo, or combinations thereof. Unless otherwise stated specifically in the specification, a haloalkylene group is optionally substituted.

“Cycloalkyl” refers to a stable non-aromatic monocyclic or polycyclic carbocyclic radical consisting solely of carbon and hydrogen atoms, which may include fused or bridged ring systems, having from three to fifteen carbon atoms, preferably having from three to ten carbon atoms, and which is saturated or unsaturated and attached to the rest of the molecule by a single bond. Monocyclic radicals include, for example, cyclopropyl, cyclobutyl, cyclopentyl, cyclohexyl, cycloheptyl, and cyclooctyl. Polycyclic radicals include, for example, adamantyl, norbornyl, decalinyl, 7,7-dimethyl-bicyclo[2.2.1]heptanyl, and the like. A “cycloalkylene” is a divalent or multivalent cycloalkyl, which typically connects one portion a molecule to a radical group or connects two or more radical groups. Unless otherwise stated specifically in the specification, a cycloalkyl (or cycloalkylene) group is optionally substituted.

“Heteroalkylene” refers to an alkylene group, as defined above, comprising at least one heteroatom (e.g., N, O, P or S) within the alkylene chain or at a terminus of the alkylene chain. In some embodiments, the heteroatom is within the alkylene chain (i.e., the heteroalkylene comprises at least one carbon-heteroatom-carbon bond). In other embodiments, the heteroatom is at a terminus of the alkylene and thus serves to join the alkylene to the remainder of the molecule (e.g., M1-Hₐ-A-M2, where M1 and M2 are each a portion of the molecule, Hₐ is a heteroatom and A is an alkylene). Unless stated otherwise specifically in the specification, a heteroalkylene group is optionally substituted.

“Haloheteroalkylene” refers to a heteroalkylene group, as defined above, wherein at least one H is replaced by a halogen radical, for example, fluoro, chloro, bromo, iodo, or combinations thereof. Unless otherwise stated specifically in the specification, a haloheteroalkylene group is optionally substituted.

“Cycloheteroalkylene” refers to a heteroalkylene group, as defined above, further comprising a cycloalkylene as define above (e.g., M1-H-A-Cy-M2, where M1 and M2 are portions of the molecule, H is a heteroatom, A is an alkylene, and Cy is a cycloalkylene. Unless otherwise stated specifically in the specification, a cycloheteroalkylene group is optionally substituted.

As used herein, “arylene” refers to a divalent or multivalent group which links a portion of a molecule to a radical group, two or more radical groups, or a portion of a first molecule to a portion of a second molecule. Unless stated specifically otherwise, an arylene is optionally substituted.

“Heteroaryl” refers to a 5- to 14-membered ring system radical comprising one to thirteen carbon atoms, one to six heteroatoms selected from the group consisting of nitrogen, oxygen and sulfur, and at least one aromatic ring. For purposes of this disclosure, the heteroaryl radical may be a monocyclic, bicyclic, tricyclic or tetracyclic ring system, which may include fused or bridged ring systems; and the nitrogen, carbon or sulfur atoms in the heteroaryl radical may be optionally oxidized; the nitrogen atom may be optionally quaternized. Examples include, but are not limited to, azepinyl, acridinyl, benzimidazolyl, benzothiazolyl, benzindolyl, benzodioxolyl, benzofuranyl, benzooxazolyl, benzothiazolyl, benzothiadiazolyl, benzo[b][1,4]dioxepinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzotriazolyl, benzo[4,6]imidazo[1,2-a]pyridinyl, carbazolyl, cinnolinyl, dibenzofuranyl, dibenzothiophenyl, furanyl, furanonyl, isothiazolyl, imidazolyl, indazolyl, indolyl, indazolyl, isoindolyl, indolinyl, isoindolinyl, isoquinolyl, indolizinyl, isoxazolyl, naphthyridinyl, oxadiazolyl, 2-oxoazepinyl, oxazolyl, oxiranyl, 1-oxidopyridinyl, 1-oxidopyrimidinyl, 1-oxidopyrazinyl, 1-oxidopyridazinyl, 1-phenyl-1H-pyrrolyl, phenazinyl, phenothiazinyl, phenoxazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, tetrahydroquinolinyl, thiazolyl, thiadiazolyl, triazolyl, tetrazolyl, triazinyl, and thiophenyl (i.e. thienyl). “Heteroarylene” is a divalent or multivalent heteroaryl radical. Unless stated otherwise specifically in the specification, heteroaryl and heteroarylene groups are optionally substituted.

As used herein, “haloheteroarylene” refers to a heteroarylene group, as defined above, wherein at least one H is replaced by a halogen radical, for example, fluoro, chloro, bromo, iodo, or combinations thereof. Unless otherwise stated specifically in the specification, a haloheteroarylene group is optionally substituted.

The term “substituted” used herein means any of the above groups (e.g., alkyl, alkylene, alkylamino, alkylaminoalkyl, alkoxy, aryl, arylene, carbocyclyl, cycloalkyl, cycloalkylene, cycloheteroalkylene, haloalkyl, haloalkylene, haloheteroalkylene, heteroalkylene, heterocyclyl, heteroaryl and/or heteroarylene) wherein at least one hydrogen atom is replaced by a bond to a non-hydrogen atom such as, but not limited to: a halogen atom such as F, Cl, Br, and I; an oxygen atom in groups such as hydroxyl groups, alkoxy groups, and ester groups; a sulfur atom in groups such as thiol groups, thioalkyl groups, sulfone groups, sulfonyl groups, and sulfoxide groups; a nitrogen atom in groups such as amines, amides, alkylamines, dialkylamines, arylamines, alkylarylamines, diarylamines, N-oxides, imides, and enamines; a silicon atom in groups such as trialkylsilyl groups, dialkylarylsilyl groups, alkyldiarylsilyl groups, and triarylsilyl groups; and other heteroatoms in various other groups. “Substituted” also means any of the above groups in which one or more hydrogen atoms are replaced by a higher-order bond (e.g., a double- or triple-bond) to a heteroatom such as oxygen in oxo, carbonyl, carboxyl, and ester groups;

and nitrogen in groups such as imines, oximes, hydrazones, and nitriles.

For example, “substituted” includes any of the above groups in which one or more hydrogen atoms are replaced with —NR_{g}Rₕ, —NR_{g}C(═O)R^{h}—NR_{g}C(═O)Rₕ, —NR_{g}C(═O)NR_{g}Rₕ, —NR_{g}C(═O)ORₕ, —NR_{g}SO₂Rₕ, —OC(═O)NR_{g}Rₕ, —OR_{g}, —S R_{g}, —SOR_{g}, —SO₂R_{g}, —OSO₂R_{g}, —SO₂OR_{g}, ═NSO₂R_{g}Rₕ. “Substituted” also means any of the above groups in which one or more hydrogen atoms are replaced with —C(═O)R_{g}, —C(═O)OR_{g}, —C(═O)NR_{g}Rₕ, —CH₂SO₂R_{g}, —CH₂SO₂NR_{g}Rₕ. In the foregoing, R_{g} and Rₕ are the same or different and independently hydrogen, alkyl, alkoxy, alkylaminyl, thioalkyl, aryl, aralkyl, cycloalkyl, cycloalkylalkyl, haloalkyl, heterocyclyl, N-heterocyclyl, heterocyclylalkyl, heteroaryl, N-heteroaryl and/or heteroarylalkyl. “Substituted” further means any of the above groups in which one or more hydrogen atoms are replaced by a bond to an aminyl, cyano, hydroxyl, imino, nitro, oxo, thioxo, halo, alkyl, alkoxy, alkylaminyl, thioalkyl, aryl, aralkyl, cycloalkyl, cycloalkylalkyl, haloalkyl, heterocyclyl, N-heterocyclyl, heterocyclylalkyl, heteroaryl, N-heteroaryl and/or heteroarylalkyl group. In addition, each of the foregoing substituents may also be optionally substituted with one or more of the above substituents.

Embodiments of the present disclosure generally include substrates that a coating layer (e.g., a first or single layer coating and/or a weatherproof coating) may be applied. As contemplated herein, the substrates of the present disclosure are not particularly limited. In some embodiments, the substrate is planar or flat with two substantially planar sides (e.g., a sheet). In some embodiments, the substrate comprises cellulose fiber.

A “cellulose fiber” or grammatical equivalent refers to fibrous molecules generally having the structure shown below:

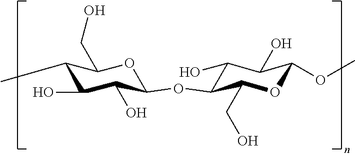

wherein n is an integer greater than 0, for example ranging from 1 to 15,000. A typical example of a substrate comprising cellulose (i.e., a cellulosic substrate) is paper. Paper may comprise cellulose fibers such as wood fibers, cotton fibers, as well as other cellulosic fibers, including recycled cellulosic fibers. Particular embodiments are directed to a substrate that is paper comprising cellulose fibers, for example, cellulosic fibers from recycled paper. The substrate of the target may be impregnantly covered with a weatherproof coating, when the weatherproof coating penetrates the surface of the substrate to at least some degree. In some embodiments, a first layer coating of a visually reactive dye is applied over the weatherproof coating. In other embodiments, the weatherproof coating is applied over the first layer coating. In other embodiments, a second coating of leuco dye or other visually reactive dye is applied on the first layer coating. In some embodiments, the single layer coating comprises the weatherproof coating (e.g., the media includes the weatherproof coating).

A “cross-link” refers to a covalent molecular bridge or linkage between two or more components (e.g., between cellulose fiber(s) and cellulose fiber(s), between polymer(s) and polymer(s), between cellulose fiber(s) and polymer(s)). Both intra and inter-molecular covalent attachments of the aforementioned components and combinations are meant to be included.

A “polymer” or “polymer molecule” refers to a chemical substance that has a molecular structure comprising a number of subunits (i.e., monomers or repeat units) bonded together to form a molecular chain or backbone. Polymers include, for example, nylon, polyvinyl chloride, polystyrene, polyethylene, polypropylene, polyacrylonitrile, polyacrylic acid, polyacrylate, and the like. In some embodiments, the first polymer comprises at least one polyacrylic polymer, at least one polystyrene polymer, or combinations thereof.

In some embodiments, a first polymer or a second polymer is a copolymer. A “copolymer” refers to a polymer having more than one species of subunits included in the polymer backbone. A copolymer may be a block or random copolymer. In certain embodiments, a copolymer comprises at least one polyacrylic polymer and at least one polystyrene polymer.

“Acrylic polymer” or “polyacrylic polymer” or their grammatical equivalents refer to a polymer comprising the following structure:

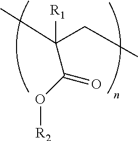

wherein R₁ is, at each occurrence, independently H or alkyl (e.g., methyl, ethyl), R₂ is, at each occurrence, independently H or alkyl (e.g., methyl, ethyl, butyl, 2-ethylhexyl) and n is an integer greater than 1. Additionally, polyacrylic polymers include polyacrylonitrile and polyacrylate polymers. Polyacrylic polymers also include, but are not limited to, polyacrylic acid, polymethacrylic acid, polymethyl methacrylate, poly-butyl acrylate, or poly 2-ethylhexyl acrylate. In certain embodiments, a polyacrylic polymer comprises mixtures of polyacrylic polymers.

“Styrene polymer” or “polystyrene polymer” refers to polymer comprising the following structure:

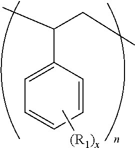

wherein R₁ is, at each occurrence, independently alkyl, haloalkyl, hydroxyl, alkoxy, or halo, x is an integer ranging from 0 to 5, and n is an integer greater than 1. Examples of polystyrene polymers include polystyrene.

A “styrene acrylic polymer” or “polystyreneacrylic polymer” refers to a copolymer comprising at least one polystyrene polymer and at least one polyacrylic polymer.

Such polymers and copolymers may be synthesized by methods well known in the art, for example, by emulsion copolymerization. Accordingly, in some embodiments, the weatherproof coating further comprising a plurality of second polymers, for example, wherein the second polymers comprise are copolymer. In some more specific embodiments, the first polymer comprises a polyacrylic polymer the second polymer comprises a styrene acrylic copolymer. In another particular embodiment, the first and second polymers are the copolymers present in Lucidene®605, an emulsion prepared and sold by the Rohm and Haas Company of Charlotte, N.C. (“Rohm and Haas”). In yet another particular embodiment, the weatherproof coating is derived from Rite in the Rain® Formula #22154A, a product manufactured and sold by Northwest Coatings Corp. of Oak Creek, Wis. (“NW Coatings”).

Without wishing to be bound by theory, Applicants have discovered that the pH of the coating layer can be used as a means for influencing the reactivity of a dye/media composition. Accordingly, in some specific embodiments, the weatherproof coating is acidic. In some more specific embodiments, the media comprises a weatherproof coating and the weatherproof coating is acidic.

Additionally, in some embodiments, a weatherproof composition is applied to the substrate that changes pH (e.g., via evaporation) as it forms the weatherproof layer. In some embodiments, the weatherproof composition comprises a basic amine compound (e.g., ammonia). In some embodiments, the pH of the weatherproof composition changes from basic (i.e., greater than pH 7.0) to acidic (i.e., less than pH 7.0) as it forms the weatherproof layer. In any of the foregoing embodiments, the weatherproof composition may be applied separately or as a component of the single layer coating (e.g., included in the media)

A. Target and Substrate

As described in detail herein, the present disclosure is directed to a target comprising a first or single layer coating that detectably changes color as a projectile penetrates a substrate. The dyes causing the color change are more durable and are not susceptible to physical defects caused by traditional targets of this type.

Without wishing to be bound by theory, dyes of this type undergo a color change as a result of the application of thermal energy (e.g., heat). Applicant has unexpectedly found that a chemical change can be induced by applying kinetic energy to a substrate containing a dye encapsulated in media (e.g., a leuco dye). The first or single layer coating that is activated (i.e., detectably changes color) with kinetic energy can be used in targets for weapons such as firearms.

Accordingly, some embodiments provide a target comprising a substrate having a thickness between 0.001 mm and 1.0 mm and two substantially planar sides, a first or single layer coating comprising an encapsulated dye and media, wherein the dye detectably changes color when kinetic energy is applied to the target. In some embodiments the target includes a second layer coating comprising an encapsulated dye and media. In some embodiments, the first layer and second layer are different colors. In some embodiments, the first and second layers comprise two different dyes.

In some more specific embodiments, the dye is a leuco dye (e.g., crystal violet lactone, phenolphthalein, thymolphthalein, and/or redox indicators). In certain embodiments, the dye is a lactone, a phthalein, an oxazine, a redox indicator, or a combination thereof. In some more specific embodiments, the dye is a lactone or a phthalein. In one more specific embodiment, the dye is a lactone (e.g., crystal violet lactone). In certain other embodiments, the dye is a phthalein (e.g., phenolphthalein or thymolphthalein). Phthalein dyes are a class of triarylmethane dyes mainly used as pH indicators, due to their ability to change colors depending on pH. They are formed by the reaction of phthalic anhydride with various phenols.

Leuco dyes may also include triaryl methane phthalide dyes (e.g., Yamamoto Blue 4450) or fluoran dyes (e.g., Pergascript Black 2C). Leuco dyes may change to red / magenta (e.g., using Yamamoto Red 40), yellow (e.g., using a triarylpyridine such as Copikem Yellow 37), cyan, grey, black, blue, red-violet, yellow-green, red, violet, and the like.

The media of the target may include one or more components that aid in the visualization and detection of the change to the dye. For instance, the media may comprise developers, sensitizers, or stablizers. Developers may include an organic acid such as a phenol (e.g., bisphenol A, bisphenol S), a sulfonyl urea (e.g., 4,4′-bis(p-tolylsulfonylureido)diphenylmethane or Pergafast 201), zinc salts of substituted salicylic acids (e.g., zinc di-tert-butylsalicylate). Sensitizers may include ethers (e.g., 1,2-bis-(3-methylphenoxy)ethane or 2-benzyloxynapthalene). Stabilizers may include multifunctional phenols. In some embodiments, the media is acidic (e.g., having a pH less than 7.0). In some embodiments, the media has a pH less than about 6.5, 6.0, 5.5, 5.0, 4.5, 4.0, 3.5, 3.0, 2.5, 3.0, 2.5, 2.0, 1.5, or 1.0. In some embodiments, the media is acidic, the encapsulated color-changing dye is at a pH that is less acidic than the media, and in response to kinetic energy the dye may be released from encapsulation and exposed to the more acidic pH of the media, thereby causing the color-changing dye to change color.

Again, without wishing to be bound by theory, it is thought that the substrate in combination with the single layer coating and optional weatherproof coating have a stiffness that allows for an efficient transfer of kinetic energy when applied to the substrate and dye. That is, kinetic energy is efficiently substantially dispersed equally in perpendicular directions of at least one of the substantially planar sides (i.e., the x-y directions) when the kinetic energy is applied to the target (e.g., when a bullet strikes the target from the z direction).

Accordingly, some embodiments provide a substrate having a Taber stiffness greater than about 10 mN, greater than about 15 mN, greater than about 20 mN, greater than about 30 mN, greater than about 40 mN, greater than about 50 mN, greater than about 75 mN, greater than about 100 mN, greater than about 125 mN, greater than about 150 mN, greater than about 175 mN, greater than about 200 mN, greater than about 225 mN, greater than about 250 mN, greater than about 300 mN, greater than about 325 mN, greater than about 350 mN, greater than about 375 mN, greater than about 400 mN, greater than about 425 mN, greater than about 450 mN, greater than about 475 mN, greater than about 500 mN, greater than about 750 mN, greater than about 1000 mN, greater than about 1250 mN, greater than about 1500 mN, greater than about 1750 mN, greater than about 2000 mN, greater than about 2250 mN, greater than about 2500 mN, greater than about 2750 mN, greater than about 3000 mN, greater than about 3250 mN, greater than about 3500 mN, greater than about 3750 mN, greater than about 4000 mN, greater than about 4250 mN, greater than about 4500 mN, greater than about 4750 mN, greater than about 5000 mN, greater than about 5500 mN, greater than about 6000 mN, greater than about 6500 mN, greater than about 7000 mN, greater than about 7500 mN, greater than about 8000 mN, greater than about 8500 mN, or greater than about 9000 mN as measured by ISO 17025, BS 3748 or ISO 2493.

Some other embodiments provide a substrate having a Clarke stiffness greater than about 0.05 gf·cm, greater than about 0.075 gf·cm, greater than about 0.10 gf·cm, greater than about 0.15 gf·cm, greater than about 0.20 gf·cm, greater than about 0.25 gf·cm, greater than about 0.50 gf·cm, greater than about 0.75 gf·cm, greater than about 0.80 gf·cm, greater than about 0.90 gf·cm, greater than about 1.0 gf·cm, greater than about 1.1 gf·cm, greater than about 1.2 gf·cm, greater than about 1.3 gf·cm, greater than about 1.4 gf·cm, greater than about 1.5 gf·cm, greater than about 1.6 gf—cm, greater than about 1.7 gf·cm, greater than about 1.8 gf·cm, greater than about 1.9 gf—cm, greater than about 2.0 gf·cm, greater than about 2.1 gf·cm, greater than about 2.3 gf—cm, greater than about 2.3 gf·cm, greater than about 2.4 gf·cm, greater than about 2.5 gf—cm, greater than about 2.6 gf·cm, greater than about 2.7 gf·cm, greater than about 2.8 gf—cm, greater than about 2.9 gf·cm, or greater than about 3.0 gf·cm as measured by Tappi T451.

Certain other embodiments provide a substrate and single layer coating together having a Taber stiffness greater than about 10 mN, greater than about 15 mN, greater than about 20 mN, greater than about 30 mN, greater than about 40 mN, greater than about 50 mN, greater than about 75 mN, greater than about 100 mN, greater than about 125 mN, greater than about 150 mN, greater than about 175 mN, greater than about 200 mN, greater than about 225 mN, greater than about 250 mN, greater than about 300 mN, greater than about 325 mN, greater than about 350 mN, greater than about 375 mN, greater than about 400 mN, greater than about 425 mN, greater than about 450 mN, greater than about 475 mN, greater than about 500 mN, greater than about 750 mN, greater than about 1000 mN, greater than about 1250 mN, greater than about 1500 mN, greater than about 1750 mN, greater than about 2000 mN, greater than about 2250 mN, greater than about 2500 mN, greater than about 2750 mN, greater than about 3000 mN, greater than about 3250 mN, greater than about 3500 mN, greater than about 3750 mN, greater than about 4000 mN, greater than about 4250 mN, greater than about 4500 mN, greater than about 4750 mN, greater than about 5000 mN, greater than about 5500 mN, greater than about 6000 mN, greater than about 6500 mN, greater than about 7000 mN, greater than about 7500 mN, greater than about 8000 mN, greater than about 8500 mN, or greater than about 9000 mN as measured by ISO 17025, BS 3748 or ISO 2493.

Some embodiments provide a substrate and single layer coating together having a Clarke stiffness greater than about 0.05 gf·cm, greater than about 0.075 gf·cm, greater than about 0.10 gf·cm, greater than about 0.15 gf·cm, greater than about 0.20 gf·cm, greater than about 0.25 gf·cm, greater than about 0.50 gf·cm, greater than about 0.75 gf·cm, greater than about 0.80 gf·cm, greater than about 0.90 gf·cm, greater than about 1.0 gf·cm, greater than about 1.1 gf·cm, greater than about 1.2 gf·cm, greater than about 1.3 gf·cm, greater than about 1.4 gf·cm, greater than about 1.5 gf·cm, greater than about 1.6 gf·cm, greater than about 1.7 gf·cm, greater than about 1.8 gf·cm, greater than about 1.9 gf·cm, greater than about 2.0 gf·cm, greater than about 2.1 gf·cm, greater than about 2.3 gf·cm, greater than about 2.3 gf·cm, greater than about 2.4 gf·cm, greater than about 2.5 gf·cm, greater than about 2.6 gf·cm, greater than about 2.7 gf·cm, greater than about 2.8 gf·cm, greater than about 2.9 gf·cm, or greater than about 3.0 gf·cm as measured0 by Tappi T451.

Certain other embodiments provide a substrate, weatherproof coating, and single layer coating together having a Taber stiffness greater than about 10 mN, greater than about 15 mN, greater than about 20 mN, greater than about 30 mN, greater than about 40 mN, greater than about 50 mN, greater than about 75 mN, greater than about 100 mN, greater than about 125 mN, greater than about 150 mN, greater than about 175 mN, greater than about 200 mN, greater than about 225 mN, greater than about 250 mN, greater than about 300 mN, greater than about 325 mN, greater than about 350 mN, greater than about 375 mN, greater than about 400 mN, greater than about 425 mN, greater than about 450 mN, greater than about 475 mN, greater than about 500 mN, greater than about 750 mN, greater than about 1000 mN, greater than about 1250 mN, greater than about 1500 mN, greater than about 1750 mN, greater than about 2000 mN, greater than about 2250 mN, greater than about 2500 mN, greater than about 2750 mN, greater than about 3000 mN, greater than about 3250 mN, greater than about 3500 mN, greater than about 3750 mN, greater than about 4000 mN, greater than about 4250 mN, greater than about 4500 mN, greater than about 4750 mN, greater than about 5000 mN, greater than about 5500 mN, greater than about 6000 mN, greater than about 6500 mN, greater than about 7000 mN, greater than about 7500 mN, greater than about 8000 mN, greater than about 8500 mN, or greater than about 9000 mN as measured by ISO 17025, BS 3748 or ISO 2493.

Some embodiments provide a substrate, weatherproof coating, and single layer coating together having a Clarke stiffness greater than about 0.05 gf·cm, greater than about 0.075 gf·cm, greater than about 0.10 gf·cm, greater than about 0.15 gf·cm, greater than about 0.20 gf·cm, greater than about 0.25 gf·cm, greater than about 0.50 gf·cm, greater than about 0.75 gf·cm, greater than about 0.80 gf·cm, greater than about 0.90 gf·cm, greater than about 1.0 gf·cm, greater than about 1.1 gf·cm, greater than about 1.2 gf·cm, greater than about 1.3 gf·cm, greater than about 1.4 gf·cm, greater than about 1.5 gf·cm, greater than about 1.6 gf·cm, greater than about 1.7 gf·cm, greater than about 1.8 gf·cm, greater than about 1.9 gf·cm, greater than about 2.0 gf·cm, greater than about 2.1 gf·cm, greater than about 2.3 gf·cm, greater than about 2.3 gf·cm, greater than about 2.4 gf·cm, greater than about 2.5 gf·cm, greater than about 2.6 gf·cm, greater than about 2.7 gf·cm, greater than about 2.8 gf·cm, greater than about 2.9 gf·cm, or greater than about 3.0 gf·cm as measured by Tappi T451.

As indicated above, stiffness values can be tested based on a number of methods known in the art, including Taber stiffness and/or Clarke stiffness. Methods for testing stiffness include ISO 17025 (Taber Stiffness), BS 3748 (Taber Stiffness), ISO2493 (Taber Stiffness), and Tappi T451 (Clarke Stiffness). The results of these tests are expressed in terms of bending resistance (mN; Taber stiffness), bending moment (mNm; Taber stiffness), and free length in centimeters of a paper strip that bends under its own weight (gf·cm; Clarke stiffness).

The present disclosure also provides targets that are easily recyclable. That is, other targets are known to have layers containing harmful chemical components (e.g., silicon) that are not amenable to standard techniques used for processing industrial recycling. Accordingly, in some embodiments, the target is substantially free of silicone. In some more specific embodiments, the target is recyclable.

Additionally, given the simplicity of the targets (i.e., requiring only a single layer coating), targets of the present disclosure are amenable to a variety of different substrates including a film (e.g., bi-axially oriented polyethylene terephthalate) or paper and paper-related products (e.g., recycled paper, cardboard, etc.). Accordingly, in some embodiments, the substrate comprises a plurality of cellulose fibers. In some embodiments, the substrate is paper (e.g., recycled paper).

The Applicant has discovered that targets prepared according to the present disclosure are also amenable to including other coating layers so as to impart desirable characteristics unto the target. These characteristics include resistance to exposure to water (i.e., weatherproofing), increased durability and scratch resistance, recyclability as well as other desirable performance characteristics. In particular, the targets of the present disclosure may include a weatherproof coating in addition to the single layer coating that includes the dye.

Accordingly, in some embodiments, the substrate is in direct contact with and impregnantly covered by a weatherproofing coating on at least one of the two substantially planar sides, the weatherproof coating comprising a plurality of first polymers. In more specific embodiments, the substrate and weatherproof coating together comprise at least one cross-link between:

i) one of the plurality of cellulose fibers and one of the plurality of first polymers;

ii) two of the plurality of first polymers; or

iii) two of the plurality of cellulose fibers.

In some embodiments, the first polymer comprises at least one polyacrylic polymer. In more specific embodiments, the first polymer comprises at least one polystyrene polymer. In certain embodiments, the first polymer comprises a copolymer. In some embodiments, the copolymer comprises at least one polyacrylic polymer and at least one polystyrene polymer. In some more specific embodiments, the first polymer comprises polystyrene, poly-butyl acrylate, poly 2-ethylhexyl acrylate, polyacrylic acid or a mixture thereof.

In some embodiments, the weatherproof coating further comprises a plurality of second polymers. In certain embodiments, the second polymer is a copolymer. In some more specific embodiments, the first polymer comprises a polyacrylic polymer and the second polymer comprises a styrene acrylic copolymer.

In certain more specific embodiments, the density of the weatherproof coating on the target ranges from about 0.5 grams per square meter of the target to about 10.0 grams per square meter of the target. In some more specific embodiments, the density of the weatherproof coating on the target ranges from about 0.75 grams per square meter of the target to about 10.0 grams per square meter, from about 1.0 grams per square meter of the target to about 10.0 grams per square meter, from about 1.25 grams per square meter of the target to about 10.0 grams per square meter, from about 1.5 grams per square meter of the target to about 10.0 grams per square meter, from about 1.75 grams per square meter of the target to about 10.0 grams per square meter, from about 2.0 grams per square meter of the target to about 10.0 grams per square meter, from about 2.25 grams per square meter of the target to about 10.0 grams per square meter, from about 2.5 grams per square meter of the target to about 10.0 grams per square meter, from about 2.75 grams per square meter of the target to about 10.0 grams per square meter, from about 3.0 grams per square meter of the target to about 10.0 grams per square meter, from about 3.5 grams per square meter of the target to about 10.0 grams per square meter, from about 4.0 grams per square meter of the target to about 10.0 grams per square meter, from about 4.5 grams per square meter of the target to about 10.0 grams per square meter, from about 5.0 grams per square meter of the target to about 10.0 grams per square meter, from about 5.5 grams per square meter of the target to about 10.0 grams per square meter, from about 6.0 grams per square meter of the target to about 10.0 grams per square meter, from about 6.5 grams per square meter of the target to about 10.0 grams per square meter, from about 7.0 grams per square meter of the target to about 10.0 grams per square meter, or from about 7.5 grams per square meter of the target to about 10.0 grams per square meter of the target.

In some more specific embodiments, the density of the weatherproof coating on the target ranges from about 0.75 grams per square meter of the target to about 9.0 grams per square meter, from about 0.75 grams per square meter of the target to about 8.5 grams per square meter, from about 0.75 grams per square meter of the target to about 8.0 grams per square meter, from about 0.75 grams per square meter of the target to about 7.5 grams per square meter, from about 0.75 grams per square meter of the target to about 7.0 grams per square meter, from about 0.75 grams per square meter of the target to about 6.5 grams per square meter, from about 0.75 grams per square meter of the target to about 6.0 grams per square meter, from about 0.75 grams per square meter of the target to about 5.5 grams per square meter, from about 0.75 grams per square meter of the target to about 5.0 grams per square meter, from about 0.75 grams per square meter of the target to about 4.5 grams per square meter, from about 0.75 grams per square meter of the target to about 4.0 grams per square meter, from about 0.75 grams per square meter of the target to about 3.5 grams per square meter, from about 0.75 grams per square meter of the target to about 3.0 grams per square meter, from about 0.75 grams per square meter of the target to about 2.5 grams per square meter, from about 0.75 grams per square meter of the target to about 2.0 grams per square meter, from about 0.75 grams per square meter of the target to about 1.5 grams per square meter, or from about 0.75 grams per square meter of the target to about 1.0 grams per square meter of the target.

In some more specific embodiments, the weatherproof coating has a total polymer content of less than 85% by weight, based on the total weight of the weatherproof coating. In certain embodiments, the weatherproof coating has a total polymer content of less than 85%, less than 80%, less than 75%, less than 70%, less than 65%, less than 60%, less than 55%, less than 50%, less than 45%, less than 40%, less than 35%, less than 30%, less than 25%, less than 20%, less than 15%, less than 10%, less than 5%, or less than 1% by weight, based on the total weight of the weatherproof coating.

In certain embodiments of the foregoing, the weatherproof coating further comprises a wax. The amount of the wax is such that water beads up as a result of the weatherproof coating that is also printable and writable. In addition to providing water resistance and causing water to bead up on the weatherproof coating surface, the wax also provides block resistance and scratch/mar resistance. In one embodiment, the wax is paraffin wax, a polypropylene-wax mixture, a polyethylene-wax mixture, carnauba wax, microcrystalline wax, montan wax, a Fisher-Tropsch wax, beeswax, or a mixture thereof.

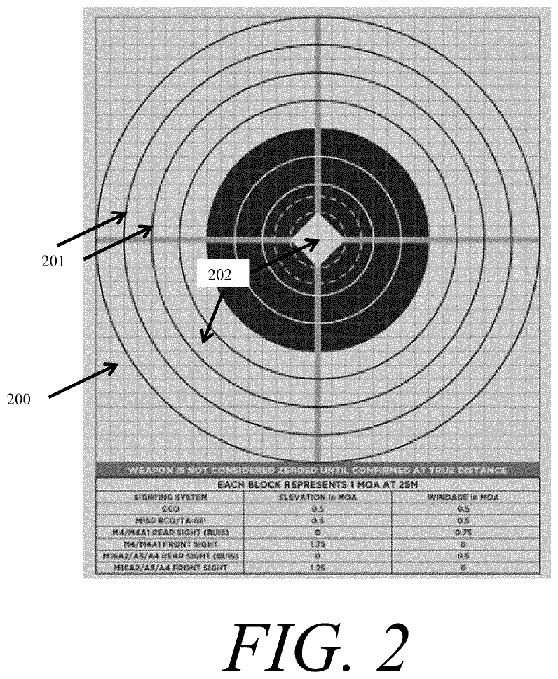

For example, FIGS. 2-5 each show an exemplary target design that can be prepared according to the various embodiments of the present disclosure. In particular, in FIG. 2, the target 200 can be printed to show concentric circles 201 and to include a portion 202 having good contrast when a leuco dye changes color (e.g., from colorless to red).

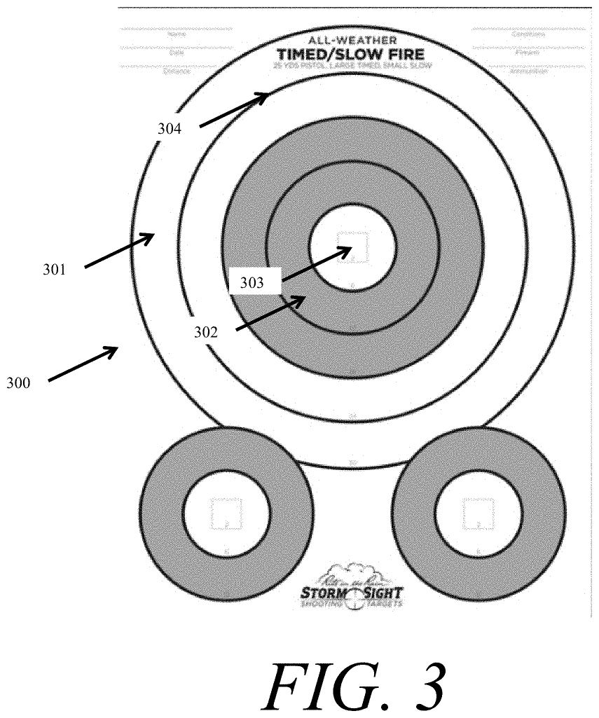

FIG. 3 is a schematic front view of a target 300 in accordance with another embodiment of the disclosure. The target is generally similar to the target described above with reference to FIG. 2. For example, the target 300 includes a target image (i.e., concentric circles) and a field surrounding a portion of the target image. The illustrated target image includes a “bull's eye” 303. The target image has a first color 301 and a second color 302 and a third color 304 used to define the outer bounds of the concentric circles.

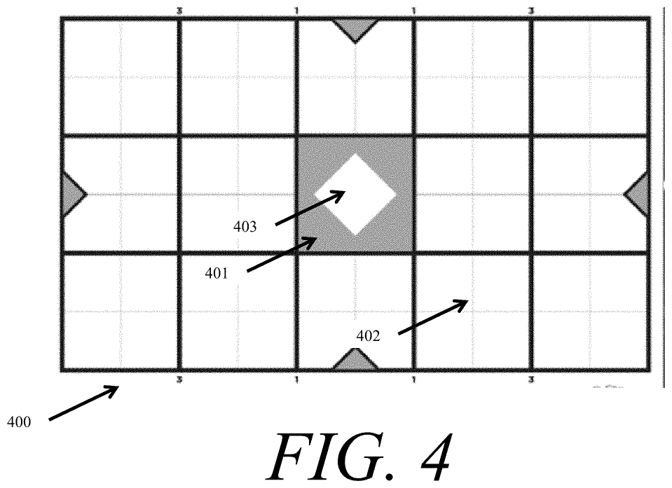

FIG. 4 shows a schematic front view of alternative target design 400. Similar to the embodiment 300 described above, the target 400 has target image including two distinct colors 401 and 402, as well as a central target image 403.

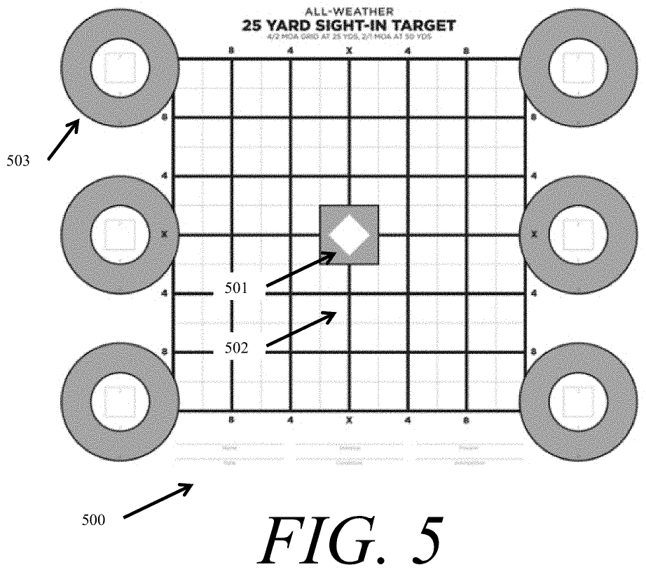

FIG. 5 shows yet another schematic front view of a target design 500. Similar to the target designs above for 200, 300, and 400, the target 500 has two distinct colors 501 and 502 as well as an alternative target image 503 in addition to a central target image 501.

As FIGS. 2-5 show, embodiments of the present invention provide a target upon which images for evaluating marksmanship are useful, while enhancing visibility when the target is struck (i.e., by color change of dyes). Additionally, the present disclosure can be made to include targets having a variety of color schemes and target designs. One advantageous aspect of targets of the present disclosure is that the paper or substrate can be manipulated and printed upon to incorporate a broad variety of designs.

In certain more specific embodiments, the plurality of cellulose fibers are derived from recycled paper. In other embodiments, greater than about 5%, greater than about 10%, greater than about 15%, greater than about 20%, greater than about 25%, greater than about 30%, greater than about 35%, greater than about 40%, greater than about 45%, greater than about 50%, greater than about 55%, greater than about 60%, greater than about 65%, greater than about 70%, greater than about 75%, greater than about 80%, greater than about 85%, greater than about 90%, greater than about 95%, greater than about 99% of the plurality of cellulose fibers are derived from recycled paper.

In some more specific embodiments, the substrate is paper. In some embodiments, the thickness of the paper ranges from about 0.007 mm to about 0.35 mm. For example, in some embodiments, the thickness of the paper ranges from about 0.007 mm to about 0.35 mm, from about 0.01 mm to about 0.35 mm, from about 0.02 mm to about 0.35 mm, from about 0.03 mm to about 0.35 mm, from about 0.04 mm to about 0.35 mm, from about 0.05 mm to about 0.35 mm, from about 0.06 mm to about 0.35 mm, from about 0.07 mm to about 0.35 mm, from about 0.08 mm to about 0.35 mm, from about 0.085 mm to about 0.35 mm, from about 0.09 mm to about 0.35 mm, from about 0.10 mm to about 0.35 mm, from about 0.15 mm to about 0.35 mm, from about 0.20 mm to about 0.35 mm, from about 0.25 mm to about 0.35 mm, or from about 0.30 mm to about 0.35 mm.

In some other embodiments, the thickness of the paper ranges from about 0.007 mm to about 0.35 mm. For example, in some embodiments, the thickness of the paper ranges from about 0.05 mm to about 0.30 mm, from about 0.05 mm to about 0.25 mm, from about 0.05 mm to about 0.20 mm, from about 0.05 mm to about 0.15 mm, from about 0.05 mm to about 0.12 mm, from about 0.05 mm to about 0.11 mm, from about 0.05 mm to about 0.10 mm, from about 0.05 mm to about 0.09 mm, from about 0.05 mm to about 0.085 mm, from about 0.05 mm to about 0.08 mm, from about 0.05 mm to about 0.75 mm, from about 0.05 mm to about 0.7 mm, from about 0.05 mm to about 0.65 mm, from about 0.05 mm to about 0.6 mm, from about 0.05 mm to about 0.55 mm, or from about 0.05 mm to about 0.5 mm.

In some more specific embodiments, the at least one cross-link comprises one of the following structures (I), (II), (III) or (IV):

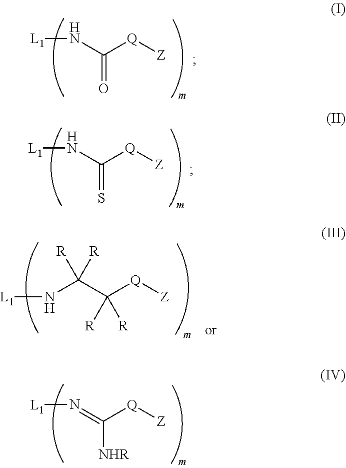

wherein:

L₁ is a multi-valent linker comprising optionally substituted alkylene, haloalkylene, cycloalkylene, heteroalkylene, haloheteroalkylene, cycloheteroalkylene, arylene, haloarylene, or haloheteroarylene;

m is an integer greater than 1;

Q is O, S or NR^{a}, wherein R^{a} is H or alkyl;

R is at each occurrence, independently H, alkyl, cycloalkyl, alkylaminoalkyl or halo; and

Z is at each occurrence, independently H, one of the first polymers or one of the cellulose fibers, provided that Z is not H for at least two occurrences.

In more specific embodiments, the cross-link comprises the following structure (I):

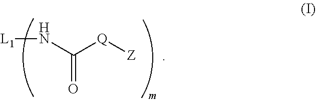

In some embodiments, the cross-link comprises the following structure (II):

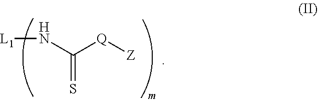

In some more specific embodiments, the cross-link comprises the following structure (III):

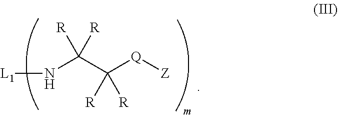

In certain embodiments, the cross-link comprises the following structure (IV):

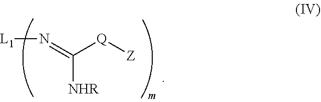

In some embodiments, the detectable color change is visibly detectable.

In certain embodiments, the kinetic energy is greater than about 150 joules. In some embodiments, the kinetic energy is greater than about 1500 joules. In some embodiments, the kinetic energy is greater than about 200 joules, greater than about 300 joules, greater than about 400 joules, greater than about 500 joules, greater than about 600 joules, greater than about 700 joules, greater than about 800 joules, greater than about 900 joules, greater than about 1000 joules, greater than about 1100 joules, greater than about 1200 joules, greater than about 1300 joules, or greater than about 1400 joules.

In some embodiments, the weatherproof coating has a moisture content less than 10% by weight, less than 8% by weight, less than 7% by weight, or less than 6% by weight based on the total weight of the weatherproof coating.

In some more specific embodiments, the weatherproof coating has a moisture content less than 10% by weight and the polymer or mixture of polymers content is less than 85% by weight, the weatherproof coating has a moisture content less than 8% by weight and the polymer or mixture of polymers content is less than 75% by weight, the weatherproof coating has a moisture content less than 7% by weight and the polymer or mixture of polymers content is less than 65% by weight, the weatherproof coating has a moisture content less than 6% by weight and the polymer or mixture of polymers is less than 60% by weight, based on the total weight of the weatherproof coating. In some embodiments, moisture content is synonymous with water content.

In some embodiments, the weatherproof and/or single layer coating further comprises a filler to provide block resistance. In some embodiments the weatherproof and/or single layer coating further comprises a filler to provide tooth for printability and writability. In some embodiments, the weatherproof and/or single layer coating further comprises a pigment. In various embodiments, the filler to provide block resistance comprises barium sulfate, the filler to provide tooth comprises calcium carbonate, and the pigment comprises titanium dioxide, respectively. The amount of barium sulfate, in one embodiment, ranges from greater than 0% by weight to about 65% by weight, about 17% by weight, or about 38% by weight, based on the total weight of the weatherproof and/or single layer coating. In some of those embodiments the weatherproof and/or single layer coating has a moisture content of 5% by weight. In another embodiment, the filler to provide block resistance comprises clay, mica, aluminum trihydrate, or mixtures thereof.

Targets having a variety of different color options and schemes are disclosed herein. The color may be obtained by providing a colored substrate, or by providing a color tinting agent in the weatherproof and/or single layer coating, wherein the color tinting agent comprises an organic or inorganic pigment dispersed in an acrylic resin or other suitable media. Alternatively, the media may also comprise different color options and schemes. That is, the media may comprise an organic or inorganic pigment dispersed therein.

In other specific related embodiments, respectively, the amount of the first polymer or combination of first and second polymers (e.g., a mixture of the first and second polymer) ranges from about 30% to about 65% by weight, while the amount of the wax ranges from about 1.5% to about 9.5% by weight; the amount of the first polymer or combination of first and second polymers is about 50% by weight, while the amount of the wax is about 2.5% by weight, where the recited amounts are based on the total weight of the weatherproof coating, the weatherproof coating having a moisture content of 5% by weight. In other specific related embodiments, respectively, the amount of the first polymer or combination of first and second polymers ranges from about 30% to about 82%, while the amount of the wax ranges from about 1.5% to about 13%; the amount of the first polymer or combination of first and second polymers is about 52.5%, while the amount of the wax is about 2.7%, where the recited amounts are based on the total weight of the weatherproof coating and the weatherproof coating having a moisture content of 5% by weight.

By way of an additional example, a substrate as described herein includes paper having the specifications described by the United States Government Publishing Office (GPO). Specific examples include, but are not limited to, printing paper water-resistant (text) book paper (JCP A220), 50 pct map lithographic-finish (JCP E10), high wet strength map lithographic-finish (JCP E20), offset map lithographic finish (JCP E30), chemical wood map lithographic finish (JCP E40) and 50 pct chart and lithographic-finish (JCP E50).

It has been surprisingly found that cellulosic substrates, when treated as described above, yield targets that are weatherproof and that can bear a single layer coating as well as printing applied by conventional printing methods such as lithography, screen printing, letter press, flexography, and rotogravure. Also, according to embodiments described herein, targets can be written upon using a pencil or an all-weather pen, even when the surface is wet, without ink feathering or paper tearing.

Some of the foregoing embodiments of the targets described above would not be suitable for use in photocopiers and laser printers. Accordingly, other embodiments include targets bearing images printed directly onto the substrate, single layer coating, and/or weatherproof coating, as well as booklets and pads comprising a plurality of the targets intended for use outdoors or in otherwise wet environments. Further, the targets of the above-disclosed embodiments are non-yellowing, biodegradable, re-pulpable and recyclable. In some embodiments, the target is substantially free of silicone (e.g., contains no silicone).

Certain embodiments of the targets of the present disclosure relate to paper and paper products that can be recycled using conventional techniques. Certain embodiments of the present disclosure meet grade definitions set forth by the Institute of Scrap Recycling Industries' Scrap Specifications Circular (2016), which is incorporated herein by reference in its entirety, specifically pages 28-31. Accordingly, in some of the foregoing embodiments, the target is Grade 1 through 52 stock, 1-S through 36-S stock, or combinations thereof. In some specific embodiments, the target is Grade 1, Grade 2, Grade 3, Grade 10, Grade 17, Grade 22, Grade 25, Grade 26, Grade 27, Grade 28, Grade 30, Grade 31, Grade 35, Grade 36, Grade 37, Grade 40, Grade 41, Grade 43, Grade 44, Grade 45, Grade 17-S, Grade 18-S, Grade 19-S, Grade 20-S, Grade 22-S, or any combination thereof. In certain embodiments, outthrows do not exceed 5%, 4%, 3%, 2%, 1%, 0.5%, 0.4%, 0.3% 0.2%, 0.1% or 0%. In certain embodiments, prohibited materials do not exceed 5%, 4%, 3%, 2%, 1%, 0.5% 0.4%, 0.3% 0.2%, 0.1% or 0%.

In some embodiments, the single layer coating further comprises the weatherproof coating. In some more specific embodiments, the weatherproof coating is acidic. In some other embodiments, the single layer coating and weatherproof coating are substantially separate (i.e., the single layer coating is layered on the weatherproof coating with some nominal amount of mixing).

One embodiment provides a composition comprising an encapsulated dye, media comprising a weatherproof composition. For example, in some embodiments, a weatherproof composition that forms the weatherproof coating according to any of the foregoing embodiments when applied to a substrate. In some embodiments, the weatherproof composition is acidic. In some embodiments, the weatherproof composition forms a weatherproof coating that is acidic.

One additional embodiment provides a device, comprising: a target that includes a flexible paper-based substrate having a first surface opposite a second surface, a pattern on the first surface of the substrate, the pattern including a plurality of visual indicators, a first coating on the first surface of the substrate, the first coating including an encapsulated dye and media, in response to kinetic energy from a projectile, the first coating changes color.

B. Method of Manufacture

The present disclosure also provides a method for making a target according to the embodiments described herein. In particular, one embodiment provides a method for preparing a target comprising contacting a substrate having a thickness between 0.001 mm and 1.0 mm and two substantially planar sides with a single layer coating composition comprising an encapsulated dye and media thereby forming a single layer coating comprising an encapsulated dye and media, wherein the dye detectably changes color when kinetic energy is applied to the target.

In some more specific embodiments, the method further comprises applying a weatherproof coating to the target. For example, in some embodiments, the weatherproof coating is applied as a weatherproof composition, the weatherproof composition comprising a first polymer. In certain more specific embodiments, the weatherproof composition comprises a first and second polymer. In further specific related embodiments, the first polymer or first and second polymers of the weatherproof composition is a copolymer or a mixture of copolymers. In some of those embodiments, the polymer is emulsified and the weatherproof composition further comprises an emulsified wax. In some specific embodiments, the amount of emulsified copolymer or mixture of copolymers ranges from about 40% by weight to about 80% by weight, while the amount of the emulsified wax ranges from about 3% by weight to about 20% by weight; the amount of the emulsified copolymer or mixture of copolymers is about 64% by weight, while the amount of the emulsified wax is about 5.3% by weight, where the recited amounts are based on the total weight of the weatherproof composition. Again, the amount of the emulsified wax is selected so that water beads up on a weatherproof coating surface that is also printable and writable.

In further related embodiments, the weatherproof composition further comprises a filler to provide block resistance, a filler to provide tooth, a pigment, or a mixture thereof. In those embodiments, respectively, the filler to provide block resistance comprises barium sulfate present in an amount ranging from greater than 0% by weight to about 40% by weight of the weatherproof composition, the filler to provide tooth comprises calcium carbonate present in an amount ranging from greater than about 0% by weight to about 10% by weight of the weatherproof composition, and the pigment comprises titanium dioxide present in an amount ranging from about 5% by weight to about 15% by weight of the weatherproof composition.

In any of the foregoing embodiments, a coating (e.g., the single layer coating or the weatherproof coating) may be applied using a flexographic process, rotogravure, an air knife, a knife coat, a reverse doctor, a Meyer rod, immersion, spray, or roll nip. Such processes are generally known to those skilled in the art. An example of a flexographic process of this embodiment is one that employs a series of rotating cylinders that pick up, transfer and apply or contact a composition (e.g., a single layer coating composition or a weatherproof composition) to the substrate. An enclosed doctor blade meters the coating onto a textured anilox roller that, in turn, transfers the coating to a variable speed printing sleeve. The latter imprints the composition onto a moving web of the substrate. The coating weight is computer monitored to maintain consistency.

The substrate is dried, in another related embodiment, using an infrared drier and air knife so as to yield a target having a moisture content ranging from about 3% by weight to about 10% by weight of the target. A moisture content that is too low will result in the target being too brittle. A moisture content that is too high can result in curling, blocking, a gummy coating layer, and other undesirable characteristics. In some embodiments, the target is allowed to air dry (i.e., at ambient temperature of about 25° C.).

In another related embodiment, a target made by the above method is provided.

Also, in particular embodiments, respectively, the composition comprises Clear Rite in the Rain® Formula #22560B, manufactured and sold by NW Coatings; the amount of weatherproof composition applied ranges from 1.7 to 2.6 pounds per ream per side; and the weatherproof composition is impregnantly applied to the substrate by a method that uses a flexographic process, rotogravure, an air knife, a knife coat, a reverse doctor, a Meyer rod, immersion, spray, or roll nip. As before, in a related embodiment, the emulsified mixture of copolymers is Lucidene® 605, a product prepared and sold by Rohm and Haas.

C. Methods of Use

Additionally, the present disclosure also provides a method for using the targets described according to embodiments disclosed herein. Specifically, one embodiment provides a method for use of a target comprising striking the target with a projectile (e.g., a bullet, arrow, pellet, BB, darts, and the like) thereby applying kinetic energy to the target and inducing a visibly detectable color change, wherein the target comprises a substrate having a thickness between 0.001 mm and 1.0 mm and two substantially planar sides and a single layer coating comprising an encapsulated dye and media.

In some embodiments, the kinetic energy is applied with a projectile (e.g., a bullet, BB, pellet, arrow, darts, etc.). In some embodiments, the method further comprises shooting and the target with a weapon (e.g., gun, bow-and-arrow, cross-bow, slingshot, blow gun, etc.). Bullets may include lead round nose bullets, wad cutter bullets, semi-wad cutter bullets, semi-jacketed bullets, full metal jacket bullets, semi-jacketed hollow point bullets, jacketed hollow point bullets, soft point bullets, armor piercing bullets, boat tail bullets, boat tail hollow point bullets, and the like.

Arrows points may include bullet points, field/combination points, blunt points, grabbing points, bowfishing points, broadheads, and incendiary/explosive points.

Arrow shafts may include alloy core/carbon cover, solid carbon, aluminum, fiberglass, wood, and the like. Vanes may include fletch, feathers, plastic, shaped/spin, and the like. The foregoing point, shaft and vane options may be included in any combination with each other, as well as other optional features (e.g., nock types).

BBs, shot, and pellet are used interchangeably herein. These terms are used to refer to small balls or pellets made of metal (e.g., lead). These projectiles are also sometimes referred to as “bird shot”, “rat shot” or “snake shot.” Pellets may range in size from about 1 mm in diameter to about 10.0 mm in diameter. Pellets can be made with a variety of different material including lead, tin, antimony, arsenic, and combinations thereof, bismuth-tin, iron-carbon (steel), iron-tungsten, iron-tungsten-nickel, tungsten-bronze, tungsten-iron-copper-nickel, tungsten matrix, tungsten polymer, tungsten-tin-iron, tungsten-tin-bismuth, tungsten-tin-iron-nickel, tungsten-iron polymer, and the like.

In some more specific embodiments, the method further comprises piercing a hole in the target. In some embodiments, the detectable color change is on the outer edge of the hole in the target. In some embodiments, the detectable color change is substantially concentric with a center of the hole. In some embodiments, the detectable color change forms a border that is greater than about 0.001 mm from the outer edge of the hole. In some embodiments, the detectable color change forms a border that is greater than about 0.001 mm, about 0.002 mm, about 0.003 mm, about 0.004 mm, about 0.005 mm, about 0.006 mm, about 0.007 mm, about 0.008 mm, about 0.009 mm, about 0.010 mm, about 0.02 mm, about 0.03 mm, about 0.04 mm, about 0.05 mm, about 0.06 mm, about 0.07 mm, about 0.08 mm, about 0.09 mm, about 0.1 mm, about 0.15 mm, about 0.20 mm, about 0.25 mm, about 0.5 mm, about 1.0 mm, about 1.5 mm, or about 2.0 mm from the outer edge of the hole.

In some of the foregoing embodiments, the substrate has a thickness between about 0.01 mm to about 0.5, about 0.05 mm to about 0.5, about 0.075 mm to about 0.5, about 0.085 mm to about 0.5, about 0.05 mm to about 0.4, about 0.05 mm to about 0.35, about 0.05 mm to about 0.3, about 0.05 mm to about 0.25, about 0.05 mm to about 0.2, about 0.085 mm to about 0.2, about 0.085 mm to about 0.15, about 0.09 mm to about 0.15, or about 0.09 mm to about 0.11. In some more specific embodiments, the substrate has a thickness of about 0.1 mm.

From the foregoing it will be appreciated that, although specific embodiments have been described herein for purposes of illustration, various modifications may be made without deviating from the spirit and scope of this disclosure. Accordingly, this disclosure is not limited except as by the appended claims.

### EXAMPLES

### Example 1

### Target Testing

A leuco dye was coated onto a paper substrate to form a single layer coating comprising an encapsulated leuco dye and media. The paper substrate was set up and three .22 caliber bullets pierced the substrate and single layer coating and applied kinetic energy to the target. FIG. 1 shows the results where a dark grey/black ring of color is detectable around the hole pierced by the bullets. It should also be noted that the remaining portions of the substrate surrounding the bullet holes remain unchanged and serve as a contrast for visible detection of where the bullets pierced the target.

All of the U.S. patents, U.S. patent application publications, U.S. patent applications, foreign patents, foreign patent applications and non-patent publications referred to in this specification are incorporated herein by reference, in their entirety to the extent not inconsistent with the present description.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A target comprising:
a substrate having a thickness between 0.001 mm and 1.0 mm and two substantially planar sides;
a single layer coating on at least one planar side of the substrate, the single layer coating comprising an encapsulated color-changing dye and a media,
wherein the encapsulated color-changing dye detectably changes color in response to kinetic energy applied to the target.

2. The target of claim 1, wherein the dye is a leuco dye.

3. The target of claim 1, wherein the color-changing dye is a lactone dye, a phthalein dye, an oxazine dye, a redox indicator, or a combination thereof

4. The target of claim 1, wherein the color-changing dye is crystal violet lactone.

5. The target of claim 1, wherein the color-changing dye is a phthalein dye.

6. The target of claim 1, wherein the target has a Taber stiffness greater than about 10 mN as measured by ISO 17025.

7. The target of claim 1, wherein the target has a Clarke stiffness greater than about 0.05 gf·cm as measured by Tappi T451.

8. The target of claim 1, wherein the substrate comprises a plurality of cellulose fibers.

9. The target of claim 1, wherein the substrate is in direct contact with and is impregnantly covered by a weatherproof material on at least one of the two substantially planar sides, the weatherproof material comprising a plurality of first polymers.

10. The target of claim 9, wherein the weatherproof material comprises a weatherproof coating between the substrate and the single-layer coating.

11. The target of claim 9, wherein the substrate and the weatherproof material together comprise at least one cross-link between:
i) one of the plurality of cellulose fibers and one of the plurality of first polymers;
ii) two of the plurality of first polymers; or
iii) two of the plurality of cellulose fibers.

12. The target of claim 9, wherein the first polymer comprises a copolymer, the copolymer comprising at least one polyacrylic polymer and at least one polystyrene polymer.

13. The target of claim 9, wherein the first polymer comprises polystyrene, poly butyl acrylate, poly 2-ethylhexyl acrylate, polyacrylic acid or a mixture thereof.

14. The target of claim 9, wherein the weatherproof material further comprises a plurality of second polymers.

15. The target of claim 10, wherein the density of the weatherproof coating on the target ranges from about 0.5 grams per square meter of the target to about 10.0 grams per square meter of the target.

16. The target of claim 9, wherein the weatherproof material further comprises a wax.

17. The target of claim 11, wherein the at least one cross-link comprises one of the following structures (I), (II), (III) or (IV): 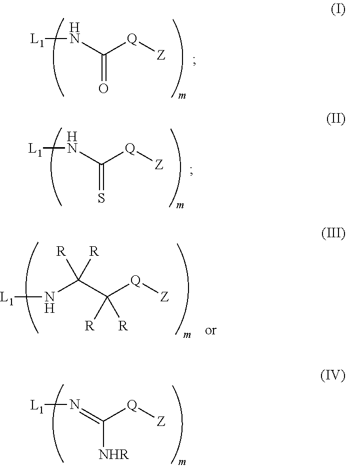
wherein:
L₁ is a multi-valent linker comprising optionally substituted alkylene, haloalkylene, cycloalkylene, heteroalkylene, haloheteroalkylene, cycloheteroalkylene, arylene, haloarylene, or haloheteroarylene;
m is an integer greater than 1;
Q is O, S or NR^{a}, wherein R^{a} is H or alkyl;
R is at each occurrence, independently H, alkyl, cycloalkyl, alkylaminoalkyl or halo; and
Z is at each occurrence, independently H, one of the first polymers or one of the cellulose fibers, provided that Z is not H for at least two occurrences.

18. The target of claim 9, wherein the single layer coating further comprises the weatherproof material.

19. A target comprising:
a substrate comprising a paper sheet having a thickness between 0.001 mm and 1.0 mm;
a coating on a planar side of the substrate, the coating comprising a color-changing dye that irreversibly changes color in response to kinetic energy from a projectile.

20. A device, comprising:
a target that includes:
a flexible paper-based substrate having a first surface opposite a second surface;
a pattern on the first surface of the substrate, the pattern including a plurality of visual indicators; and
a first coating on the first surface of the substrate, the first coating including an encapsulated dye and media, wherein the first coating changes color in response to kinetic energy from a projectile.
